(19) United States
(12) Patent Application Publication
(10) Pub. No.: US 2004/0068512 A1
(43) Pub. Date: Apr. 8, 2004

(54) Method and system for processing engineer-designed data

(76) Inventors: Ta-Cheng Liu, Taipei (TW); Jui-Chi Huang, Taipei (TW); Chiu-Juan Liu, Taipei (TW); Shu-Yun Chen, Taipei (TW); Mai-Yi Shen, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/382,168

(22) Filed: Mar. 5, 2003

(30) Foreign Application Priority Data
Oct. 2, 2002 (TW) 91122693

(51) Int. Cl. G06F 7/00

(52) U.S. Cl. 707/101

(57) ABSTRACT

A method and a system for processing engineer-designed data are provided. A data receiving/transmitting module receives engineer-designed data from an engineer design department upon receiving a data receiving request from a user through a network terminal device via a network communication system. Then, a data comparison module compares the received engineer-designed data with associated engineer-designed data stored in a database to obtain consistent engineer-designed data. A file producing module transforms the consistent engineer-designed data into a document file in a specific format. The data receiving/transmitting module transmits the transformed document file to an engineer unit corresponding to an engineering stage where the document file is formed. Finally, a data storage module stores the document file confirmed by the engineer unit in the database. By the above method and system, the user can verify and manage the engineer-designed data through the network terminal device via the network communication system.

### FIELD OF THE INVENTION

The present invention relates to methods and systems for processing engineer-designed data, and more particularly, to a method and a system for data processing by which a user can verify and manage engineer-designed data through a network terminal device via a network communication system.

### BACKGROUND OF THE INVENTION

With the coming of information technology generation, it has been substantially common, from the research and development (RD) design process to product manufacturing process, to use computer equipment that assist engineers to execute design and manufacture works, for example, Computer Aided Design (CAD) and Computer Aided Manufacturing (CAM). However, with the industry being established with certain computer aided tools, the computer aided software, such as CAD and CAM described above, has been upgraded from a two dimensional (2D) version from the early day to a three dimensional (3D) version. On the other hand, engineers responsible for designing, manufacturing, and analysis as well as the production department have gradually shifted from working individually to working as a team. Therefore, data management for the engineering department has become a current subject for developing global synchronized engineering.

Without a systematic data management, some related engineer key data may be stored in several different databases as a result of complex data process, making data search more complicated. Particularly, when one database system retrieves data from another database, the original data may change. Thus, it is difficult to guarantee uniform data in the database systems. So, for the related engineers who need to rely on data stored in the database to execute design, RD, manufacture, and even after sales service for the product, a difference in the data adopted among them certainly poses a major and negative influence in manufacture and after sales service for the product.

Take the CAM department previously described as an example, if the CAM department wishes to manufacture a batch of PCBs or other modules, the process may involve illustrating a circuit diagram of the PCB to be manufactured using a computer graphic software by the logic design department. Next, the process engineering related department and the process flow are coordinated by an engineer process liaison. Then, data files from the previously described departments or data file coordinated by the liaison are managed and saved by a data center. At last, the CAM department executes the manufacturing work according to the designed data. However, content of the circuit diagram may be modified more than once in the manufacturing process due to reasons such as stock shortage in the components, poor component efficiency, or costly components. So if the related engineering departments previously described can not acquire the updated data synchronously when the content of the circuit diagram is modified by adding or deleting, cost in designing, RD, and manufacturing in mass quantity would inevitably be wasted. Thus, a method and system for integrating and managing data is provided to solve the above-mentioned problems.

### SUMMARY OF THE INVENTION

To improve from the drawback associated with the conventional art, an objective of the present invention is to provide a method and a system for processing engineer-designed data, so as provide the user with an automation for receiving/transmitting the engineer-designed data, matching contents of the engineer-designed data, and duplicating and version updating the engineer-designed data in the database using a network terminal device via a network communication system.

Another objective of the present invention is to provide a method and a system for processing engineer-designed data, so that the user can automatically verify the engineering files based on the engineering progress using the network terminal device via the network communication system.

As embodied and broadly described herein, the invention provides a system for processing engineer-designed data, comprising: a database for storing at least the engineer-designed data, document file data, electronic form data, and data related to supervisor and unit responsible to the engineer deign; a data receiving/transmitting module that enables the user to receive or transmit the related engineer-designed data using the network terminal device; a data comparison module for matching the engineer-designed data received by the data receiving/transmitting module with the engineer-designed data stored in the database; a file producing module for transforming the matching engineer-designed data into a document file format; and a data storage module for saving the document file transformed by the file producing module in the database.

With the system for processing the engineer-designed data, the method of processing the engineer-designed data comprises commanding a data receiving/transmitting module to receive the designed data of the engineer design department when a data-receiving request issued by the user via the network terminal device is received. Next, a data comparison module is commanded to match the designed data received by the data receiving/transmitting module with the designed data stored in the database, so as to produce a matching report to be transmitted to the engineer design department. Then, a document file-producing module is commanded to transform the matching designed data into a specific file format. And according to an engineering stage for producing the file, the data receiving/transmitting module is commanded to transmit the transformed file to the engineer unit that corresponds to the engineering stage. Lastly, a data storage module is commanded to save the file confirmed by the engineering unit in the database.

By comparison to the conventional art, the method of processing the engineer-designed data and the system for the same according to the present invention provide the user with not only an automation for receiving/transmitting the engineer-designed data, matching contents of the engineer-designed data, and duplicating and version updating the engineer-designed data in the database, but also automatic verification of the engineering files based on the engineering progress using the network terminal device via the network communication system.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating application architecture of the system for processing the engineer-designed data according to the present invention;

FIG. 2 is a block diagram illustrating system architecture of the system for processing the engineer-designed data according to the present invention; and

FIG. 3 is a flow chart illustrating process steps involved in the method of processing the engineer-designed data according to the present invention.

### DETAILED DESCRIPTION OF THE PREFERRED EMBODIMENTS

In this embodiment, the system for processing the engineer-designed data is applicable to designing and manufacturing processes for a Printed Circuit Board (PCB) and its modules. And in the designing and manufacturing processes, there are at least a logic designing department for designing the PCB and its modules, a process engineering mediator for mediating the process engineering related processes and departments, a data center for storing the engineer-designed and manufactured related data, and a computer aided manufacturing department.

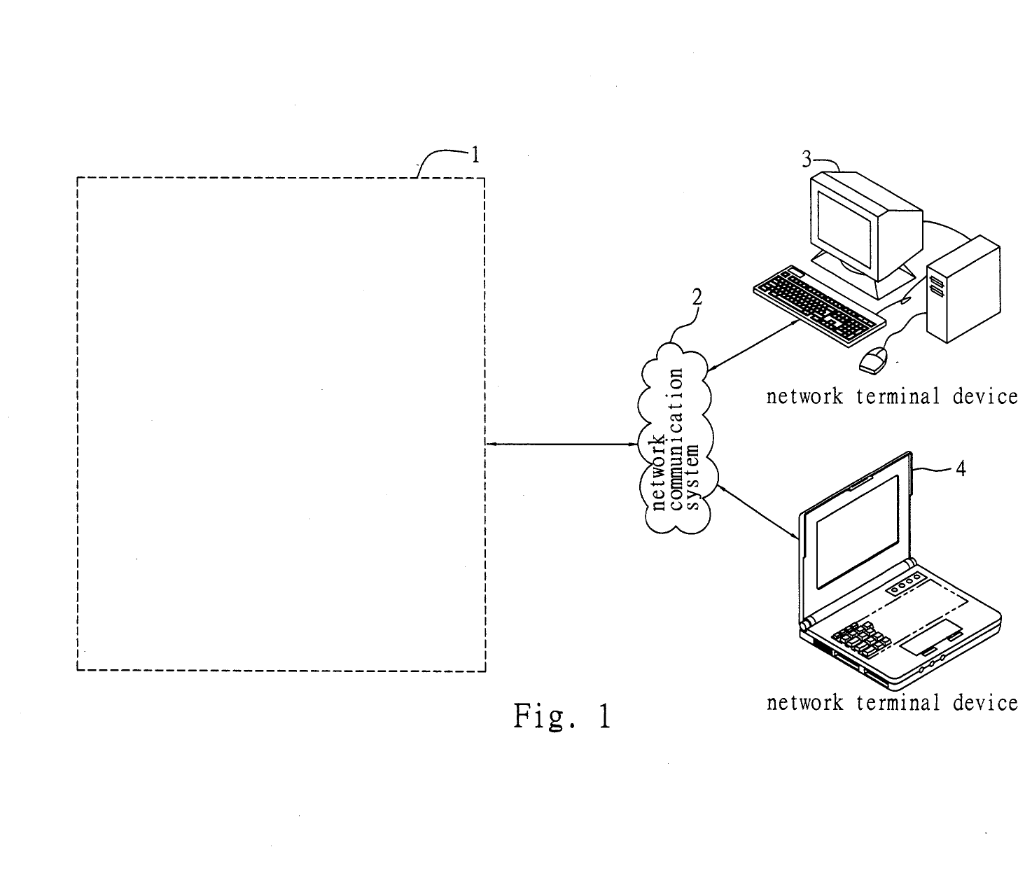

As shown in FIG. 1, the system for processing the engineer-designed data 1 is applicable to a conventional Client Server network communication system 2, and the system for processing the engineer-designed data 1 may also be built in a server end of the network communication system, so as to link the client end users of the network terminal devices 3 and 4 to the system for processing the engineer-designed data 1 built in the server end in order to receive and transmit data including engineer-designed data and document file data. Preferably, the network communication system 2 may be Internet, intranet, or extranet. The network terminal devices 3 and 4 may be a personal computer (PC), a notebook computer, or a workstation. As for the browser application program, it may include Windows Internet Explorer, Netscape Navigator, and so on. Since the client server network communication system 2, the network terminal devices, and the browser application programs are well-known hardware and software, they are not further described in detail herein.

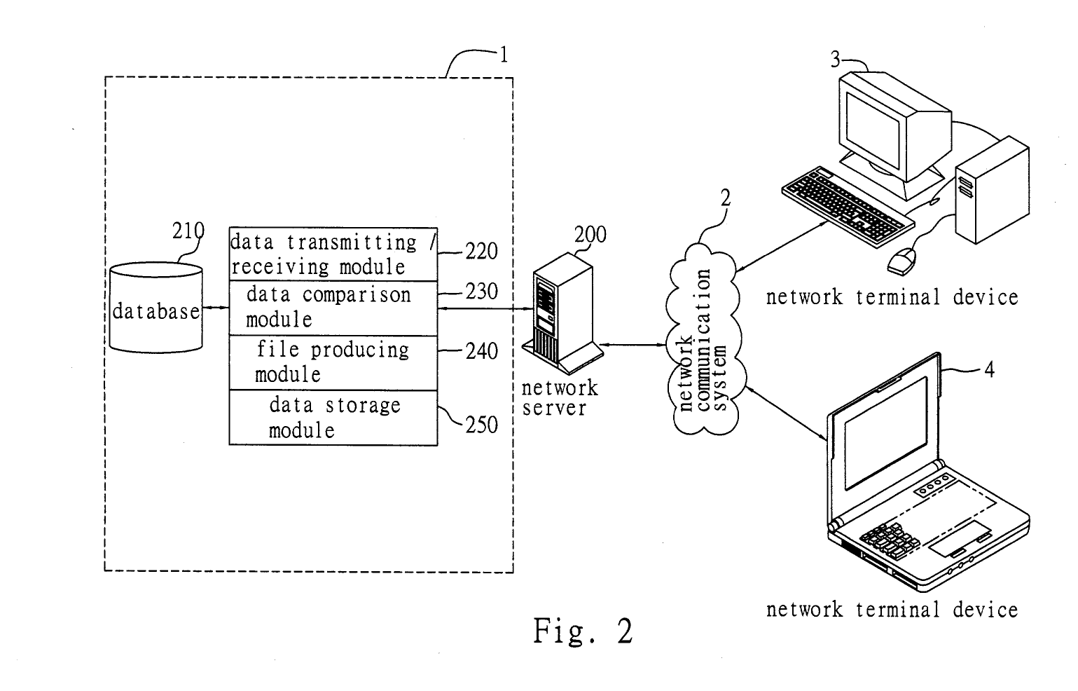

Referring to FIG. 2 for illustrating system architecture of the system for processing the engineer-designed data according to the present invention. As shown in the diagram, the system for processing the engineer-designed data 1 is coordinated with a network server 200 for linking the system 1 via the network communication system 2 to the network terminal devices 3 and 4, and for providing the network terminal devices 3 and 4 with commands for responding to the user and other needs, so as to access the data. In the present embodiment, the network terminal devices 3 and 4 are linked to the system for processing the engineer-designed data 1 via the network communication system 2 as well as the network server system 200, using the network browser application programs in the network terminal devices 3 and 4, so that the engineer-designed data and document file data are received/transmitted and accessed. The system for processing the engineer-designed data 1 comprises a database 210, a data receiving/transmitting module 220, a data comparison module 230, a file producing module 240, and a data storage module 250.

The database 210 stores at least the engineer-designed data, document file data, electronic form data, and data related to supervisors and units responsible the engineer-design input by the user via the network communication system using a network terminal device. In this embodiment, the database 210 may be an associated type database. The engineer-designed data comprises at least engineering image files of the PCB and its modules, such as image files in DWG or DXF formats, the image file in Initial Graphics Exchange Specification (IGES) standard format, or the image file in BMP, TIF, PCX, TGA, GIF formats. The document file data comprises at least the engineer-design related document file, such as text file in TXT or DOC format, and voice files in other formats. The electronic form data comprises at least the electronic form number and the data in electronic form format. As for data related to supervisors and units responsible the engineer-design, it comprises at least name, title, employee number, electronic mail (e-mail) account, and unit name for the supervisor responsible for the engineer-design. By establishing this associated type database, the system for processing the engineer-designed data 1 can rapidly find the corresponding data once the user inputs any of the data described above. It should be noted here that the data columns and its data forms described above are only examples, while their content would be more precise and detail in the practical scenario. Also, each of the data column may contains other data columns or data forms, only a part of data related to processing the engineer-designed data is shown in order to make the description more concise and clear. On the other hand, there are also many types of system architectures for the associated type database, whereas the establishment thereof is well known to one skilled in the pertinent art, so it is not further described herein.

Based on the data receiving request input by the user via the network terminal device, the data receiving/transmitting module 220 receives the related engineer-designed data transmitted by the engineer-designed related department, such that the CAM department can process the engineer-designed data accordingly. Also, the data receiving/transmitting module 220 further transmits data according to the data transmission process or engineering progress preset by the user, so that the supervisors from related engineering design and manufacture departments can execute confirmation or verification.

The data matching module 230 matches the related engineer-designed data received by the data receiving/transmitting module 220 with the related engineer-designed data stored in the database 210. It should be noted that the related engineer-designed data in the database 210 of the present embodiment is a circuit graphic file produced using software to illustrate the circuit. Since the circuit diagram may be subjected to more than one modification in terms of the design content beginning from design and manufacture of the product to even after the product is sold, there may be several different versions of the electrical circuit design diagrams for the same product. Therefore, to ensure that the CAM department manufacture product according to the latest engineer-designed data of the product, the data comparison module 230 is relied on matching the content of the related engineer-designed data. And when the data comparison module 230 produces a matching result that shows a difference in the content, the matching result is transmitted in the form of a report to the logic design department for further comparison and confirmation.

After the data comparison module 230 matches the related engineer-designed data and confirms the engineer-designed data is the latest and accurate version, the document file-producing module 240 transforms the engineer-designed data into a document file format, such that the data receiving/transmitting module 220 can transmit the transformed document file to related engineer design departments that correspond to different engineering stages for confirming and verifying the file content. In the present embodiment, transformation of the file is to re-create a file different from its original data format. For example, the image file originally saved in DWG format is transformed to DOC document file format that is transmitted by the data receiving/transmitting module 220.

The data storage module 250 stores the document file data transformed by the document file-producing module 240 and the document file verified by the data receiving/transmitting module 220 in the database 210. Furthermore, the transformed document file data and the verified document file data are duplicated and updated for their versions. And the version update does not affect the content of data before modification, so that the user can compare data contents of different versions.

With the system for processing the engineer-designed data 1, steps of processing the engineer-designed data are described below.

First of all, the data receiving/transmitting module 220 is commanded to receive the designed data of the engineer design department when the data-receiving request issued by the user via the network terminal device is received. In the present embodiment, the CAM department is set to receive via the data receiving/transmitting module 220 the data-receiving request issued by the process-engineering liaison or the data center, and to receive the related engineer-designed data issued by the logic design department according to the data-receiving request. As described above, the related engineer-designed data is the image file of the PCB electrical circuit diagram.

Next, the data comparison module 230 is commanded to match the designed data received by the data receiving/transmitting module 220 with the designed data stored in the database 210, and to transmit a match report to the engineer-designed related department. As described previously, since the PCB circuit design diagram may be subjected to more than one modification in terms of the design content beginning from design and manufacture of the product to even after the product is sold, there may be several different versions of the circuit design diagrams for the same product. Therefore, to ensure that the CAM department manufacture product according to the latest engineer-designed data of the product, the data comparison module 230 is relied on matching the content of the related engineer-designed data. And when the data comparison module 230 produces the matching result that shows a difference in the content, the matching result is transmitted in the form of a report via the data receiving/transmitting module 220 to the logic design department for further comparison and confirmation. And the confirmed matching result is then transmitted via the data receiving/transmitting module 220 to the CAM department for processing the remaining engineer-designed data.

After that, the document file-producing module 240 is commanded to transform the matching designed data into specific document file format. As described previously, the logic design department produces the PCB circuit diagram using computer graphic software, wherein the circuit diagram is saved as previously described DWG format or other graphic formats in the database 210. However, the graphic format is not suitable for confirmation and verification conducted by the supervisor or unit of the engineer-designed related department, so it needs to be transformed by the document file producing module 240 into the DOC document file format, so that the user can confirm and verify using the network terminal device.

Further, based on the engineering stage for producing the document file, the data receiving/transmitting module 220 is commanded to transmit the transformed document file to the engineering unit that corresponds to the engineering stage for verification and confirmation. As described above, the data receiving/transmitting module 220 transmits the document file to the engineering department supervisor and unit that corresponds to the engineering progress according to the current engineering progress after the document file-producing module 240 transforms the graphic file format of the PCB circuit diagram into the document file format. When the engineering progress is at the product RD stage, the document file data is transmitted by the data receiving/transmitting module 220 to the logic design department for confirmation and verification, before being transmitted by the logic design department to the process engineering coordination department for further confirmation and verification. Once the document file data is confirmed, it is transmitted back to the CAM department. And when the engineering progress is at the mass production stage, the data receiving/transmitting module 220 transmits the document file to the document center for confirmation and verification. Then, the document file is transmitted back to the CAM department after the confirmation.

Lastly, the data storage module 250 is commanded to save the document file confirmed by the engineering unit in the database. As described previously, after the data receiving/transmitting module 220 transmits the transformed file to the engineering unit that corresponds to the engineering stage for verification and confirmation and transmits back to the CAM department, the data storage module 250 is commanded to save and duplicate the data that is transmitted back. Also, the transformed document file data and the verified document file data are duplicated and updated for their versions. And the version update does not affect the data content before modification, so that the user can compare data contents of different versions.

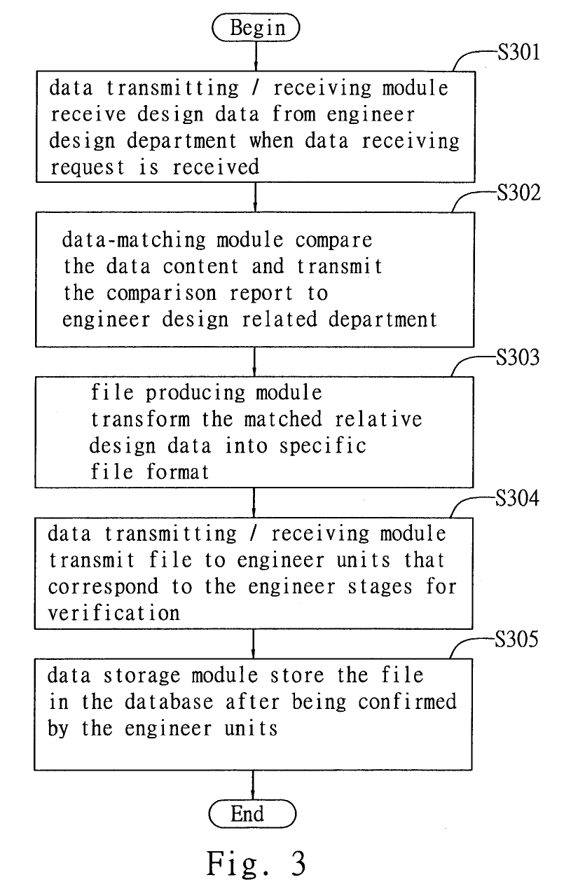

FIG. 3 illustrates process steps involved in the method of processing the engineer-designed data according to the present invention. Referring to FIG. 3, the system for processing the engineer-designed data 1 is coordinated with a network server 200 for linking the system 1 via the network communication system 2 to the network terminal device 3 or 4, so as to provide the network terminal device 3 or 4 with commands for responding to the user and other needs, as well as access to the data. And a database 210 is established to save at least the engineer-designed data, document file data, electronic form data, and data related to engineer-design responsible supervisors and units. Then, the process moves on to step S301.

In step S301, the data receiving/transmitting module 220 is commanded to receive the designed data of the engineer design department when the data-receiving request issued by the user via the network terminal device 3 or 4 is received. Then, the process moves on to step S302.

In step S302, the data comparison module is commanded to match the designed data received by the receiving/transmitting module with the designed data saved in the database 210, and to transmit a matching report to the engineer-designed related departments. Next, the process moves on to step S303.

In step S303, the document file-producing module 240 is commanded to transform the matching designed data into the specific document file format. Then, the process moves on to step S304.

In Step S304, the data receiving/transmitting module 220 is commanded based on the engineering stage for producing the document file, to transmit the transformed document file to the engineering unit that corresponds to the engineering stage for verification and confirmation. Next, the process moves on to step S305.

In step S305, the data storage module 250 is commanded to save the document file confirmed by the engineering unit in the database 210.

According to the present invention, the method of processing the engineer-designed data and the system for the same provide the user with not only an automation for receiving/transmitting the engineer-designed data, matching contents of the engineer-designed data, and duplicating and version updating the engineer-designed data in the database, but also automatic verification of the engineering files based on the engineering progress using the network terminal device via the network communication system.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for processing engineer-designed data, for allowing a user to executing and monitoring the engineer-deigned data through a network terminal device via a network communication system, with the engineer-designed data being stored in a database, the method comprising the steps of:
upon obtaining a data receiving request from the user via the network terminal device, having a data receiving/transmitting module receive associated engineer-designed data from an engineer design department;
having a data comparison module compare the received engineer-designed data from the data receiving/transmitting module with the engineer-designed data stored in the database to obtain consistent engineer-designed data so as to generate and transmit a data comparison report with the consistent engineer-designed data to the engineer design department;
having a file producing module transform the consistent engineer-designed data into a document file in a specific format;
having the data receiving/transmitting module transmit the document file to an associated engineer unit corresponding to an engineering stage where the document file is formed, allowing the engineer unit to verify the document file; and
having a data storage module for storing the verified document file in the database.

2. The method of claim 1, wherein the network terminal device is selected from the group consisting of a workstation, personal computer, notebook computer, palmtop computer, personal digital assistant (PDA), and mobile phone.

3. The method of claim 1, wherein the network communication system is selected from the group consisting of Internet, intranet, and extranet.

4. The method of claim 1, wherein the network communication system is a wired communication system or a wireless communication system.

5. The method of claim 1, wherein the database is an associative database.

6. A system for processing engineer-designed data, for allowing a user to executing and monitoring the engineer-deigned data through a network terminal device via a network communication system, with the engineer-designed data being stored in a database, the system comprising:
a database for storing at least the engineer-designed data, document file data, electronic form data, and engineer-designed related unit data input by the user through the network terminal device via the network communication system;
a data receiving/transmitting module for receiving associated engineer-designed data from an engineer design department upon receiving a data receiving request from the user via the network terminal device, for facilitating the engineer-designed data being processed by a computer-aided manufacturing department;
a data comparison module for comparing the received engineer-designed data from the data receiving/transmitting module with associated engineer-designed data stored in the database;
a file producing module for determining the compared engineer-designed data of the latest and accurate version and transforming the engineer-designed data into a document file in a specific format; and
a data storage module for storing the document file transformed by the file producing module and document files verified by the data receiving/transmitting module at different engineering stages in the database, and duplicating and updating the transformed document file and the verified document file.

7. The system of claim 6, wherein the network terminal device is selected from the group consisting of a workstation, personal computer, notebook computer, palmtop computer, personal digital assistant (PDA), and mobile phone.

8. The system of claim 6, wherein the network communication system is selected from the group consisting of Internet, intranet, and extranet.

9. The system of claim 6, wherein the network communication system is a wired communication system or a wireless communication system.

10. The system of claim 6, wherein the database is an associative database.
